(19) United States
(12) Patent Application Publication
(10) Pub. No.: US 2011/0106362 A1
(43) Pub. Date: May 5, 2011

(54) CONTROL FOR AN AUTONOMOUS CONVEYER VEHICLE AND METHOD FOR OPERATING AN AUTONOMOUS CONVEYER VEHICLE

(75) Inventor: Christian Seitz, Munchen (DE)

(73) Assignee: SIEMENS AKTIENGESELLSCHAFT, MÜNCHEN (DE)

(21) Appl. No.: 13/001,530

(22) PCT Filed: Jun. 9, 2009
(86) PCT No.: PCT/EP2009/057071

§ 371 Date: Dec. 27, 2010

(30) Foreign Application Priority Data
Jun. 27, 2008 (DE) 10 2008 030 546.4

(51) Int. Cl. G05D 1/02; G06F 19/00; G05B 19/02

(52) U.S. Cl. 701/24

(57) ABSTRACT

A sensor-based control permits an autonomous conveyor vehicle to carry out intelligent driving behavior which takes into account individual properties of the freight or cargo that is to be conveyed. For example, the acceleration and braking behavior of the autonomous conveyor vehicle can be selected as a function of the stability of the freight or cargo. A route or a parking place at which particular environmental conditions (e.g., temperature, humidity) occur can be planned using sensor measured values of a sensor network. The relatively advanced intelligence of the autonomous conveyor vehicle optimizes the handling of the freight or cargo and obviates the need for camera-based monitoring. For example, the loss of the freight or cargo from the loading surface can be detected by a sensor and signaled automatically.

Autonomous conveyor vehicles (Autonomous Guided Vehicles (AGV)) transport goods autonomously. This means that no vehicle driver is required.

Previously autonomous guided vehicles needed a camera-based monitoring system to guarantee error-free operation. It is also necessary to configure an autonomous guided vehicle individually where a specific behavior is required.

The desired object is thus to specify a control for an autonomous guided vehicle and a method for operating an autonomous guided vehicle in which outlay for camera-based monitoring or manual configuration is reduced.

This object is achieved by the independent claims. Developments of the invention are defined in the dependent claims.

In the control for an autonomous guided vehicle, the autonomous guided vehicle has a loading area onto which freight or cargo can be loaded. The control is also configured to control the way in which the autonomous guided vehicle moves as a function of a property of the freight or cargo.

The autonomous guided vehicle possesses such a control.

In the method for operating an autonomous guided vehicle, freight or cargo is loaded onto a loading area of the autonomous guided vehicle. Subsequently a control controls the driving behavior of the autonomous guided vehicle as a function of a property of the freight or cargo.

The control and the method increase the independence of the autonomous guided vehicle. This can now adapt its driving behavior to a property of the freight or cargo. As a result of increasing product diversity, very many different types of items of freight or cargo, on which different demands will be made, will be transported in future. The control and the method make it possible to adapt the driving behavior to a property of the freight or cargo. This ensures that the freight or cargo is handled in the optimum manner. The effort of manual configuration of the autonomous guided vehicle or for a camera-based monitoring is reduced or dispensed with.

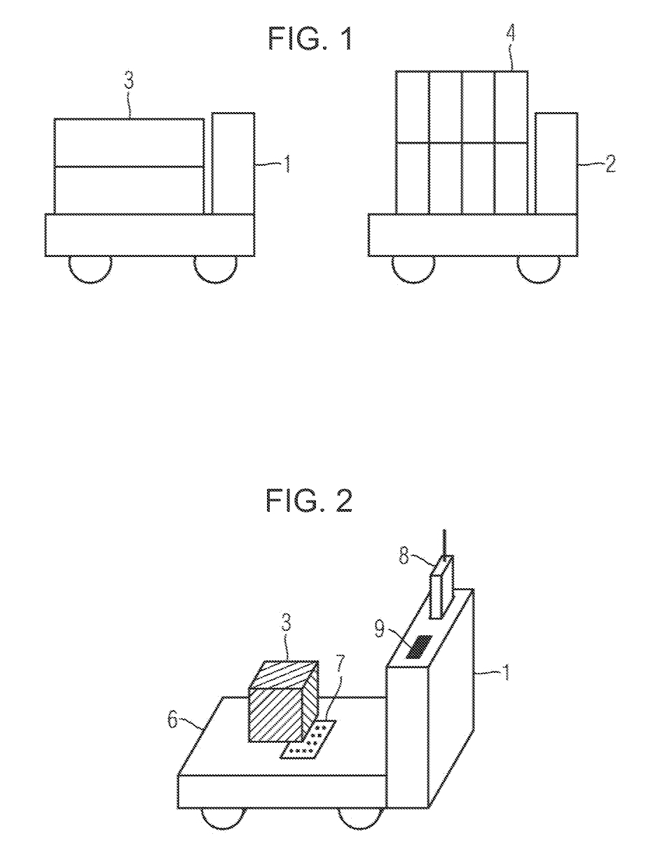

An explanation is given below of exemplary embodiments of the invention which refer to FIGS. 1 to 3. The figures show:

FIG. 1 an autonomous guided vehicle with freight or cargo and a second autonomous guided vehicle with unstable freight or cargo,

FIG. 2 a detailed view of an autonomous guided vehicle,

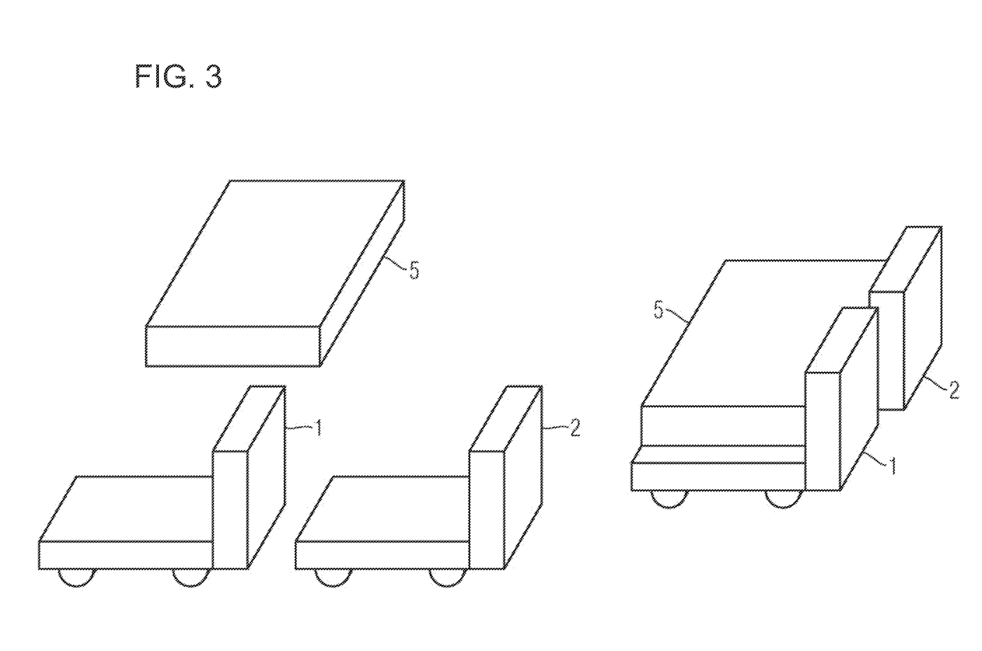

FIG. 3 joint transport of bulky freight or cargo by two autonomous guided vehicles.

FIG. 1 shows two scenarios for the operation of an autonomous guided vehicle. An autonomous guided vehicle 1 is loaded with freight or cargo 3. The freight or cargo 3 has favorable dimensions for transport. FIG. 1 further shows a second autonomous guided vehicle 2, which is loaded with unstable freight or cargo 4. The favorable dimensions of the freight or cargo 3 allow the autonomous guided vehicle 1 to brake more heavily than the second autonomous guided vehicle 2. The latter must brake more carefully if loss of or damage to the unstable freight or cargo 4 is to be avoided.

The second autonomous guided vehicle 2 controls its driving behavior as a function of the property of the unstable freight or cargo 4. The property of the unstable freight or cargo 4 is in this case its instability. Accordingly the second autonomous guided vehicle 2 controls its driving behavior by reducing its braking acceleration by a required degree.

FIG. 2 shows a detailed view of an autonomous guided vehicle 1. A loading area 6 of the autonomous guided vehicle 1 is loaded with freight or cargo 3. FIG. 2 further shows a sensor 7 which measures position or weight of the freight or cargo 3. The sensor 7 can for example be embodied as a pressure sensor which is disposed below a loading surface of the autonomous guided vehicle and measures the weight of the entire load. The sensor 7 can however also (and if necessary in addition to the previously mentioned embodiment) consist of one or more sensors or of a sensor array, which not only measures the presence of the freight or cargo 3 but also its position on the loading area 6. As soon as an evaluation of the signals of the sensor 7 reveals that the freight or cargo 3 has slipped or fallen from the loading area 8, the autonomous guided vehicle 1 is stopped or a warning message is output. An operator of the autonomous guided vehicle 1 is thus provided with a signal that the freight or cargo 3 has slipped or has fallen from the loading area 6, so that he can place said item correctly again on the loading area 6.

In a variant of this exemplary embodiment a control of the autonomous guided vehicle 1 includes a wireless interface 8 which is likewise depicted in FIG. 2. The wireless interface 8 receives the property of the freight or cargo 3. A processing unit 9 determines from the property of the freight or cargo 3 limit values for acceleration, negotiation of a curve or braking of the autonomous guided vehicle 1, below which freight or cargo 3 will not slip off or be damaged. The driving behavior of the autonomous guided vehicle 1 is controlled so that these limit values are not exceeded. This allows the driving behavior to be adapted to the freight or cargo to a particular degree. Depending on the stability of the freight or cargo 3, braking, acceleration processes and the negotiation of curves can be controlled so that no freight or cargo 3 slips from the loading area 6 or is damaged. For example a transport journey with live animals as freight or cargo 3 can be undertaken with very narrow limit values for acceleration, negotiating curves and braking so that the animals are conveyed with the greatest possible level of protection.

In a development, for better control of the driving behavior the autonomous guided vehicle is equipped with an acceleration sensor. On the basis of measured values of the acceleration sensor the driving behavior of the autonomous guided vehicle 1 will be controlled so that the said limit values are not exceeded.

The wireless interface 8 is used in a further scenario to read out RFID tags attached to the freight or cargo which specify the property of the freight or cargo 3. For example a type of goods (live animals, electrical equipment, etc.) or another property of the freight or cargo 3 such as instability, dimensions, bulk, can be stored on the RFID tag. In this way the control of the autonomous guided vehicle 1 obtains information via the wireless interface 8 about the property of the freight or cargo 3.

As an alternative the wireless interface 8 receives this information within the framework of a transport order which is transferred for example from a control center or from a user's mobile terminal.

Since the freight or cargo 3 can consist of different items of freight or cargo which have different properties and requirements in relation to maximum acceleration, negotiation of curves, or braking, it is necessary at this point for a processor unit 9 to analyze the collected data. Within the framework of the analysis, for all loaded items of freight or cargo, the minimum of their maximum acceleration values is selected in each case as a limit value for the driving behavior of the autonomous guided vehicle 1.

FIG. 3 shows a further scenario for using the autonomous guided vehicle 1. In this scenario bulky freight or cargo 5 is to be transported for which the autonomous guided vehicle 1 is not dimensioned sufficiently large. For this reason a second autonomous guided vehicle 2 is employed in order to share the transportation of the bulky freight or cargo 5. In this case the autonomous guided vehicle 1 and the second autonomous guided vehicle 2 each have a wireless communication interface to communicate with one another and to synchronize their driving behavior so that the bulky freight or cargo 5 can be carried. As part of this synchronization measured values, for example of the sensor 7 shown in FIG. 2 and of the previously mentioned acceleration sensor, are exchanged continuously during the journey.

In a further usage scenario the property of the freight or cargo 3 requires specific environmental conditions. For example refrigerated goods can be involved, such as frozen food or freight or cargo which may not be subjected to sunlight, to too high a humidity or to frost. In this scenario the autonomous guided vehicle 1 plans a route in a first variant on which the required environmental conditions are always provided. In a second variant a parking place is selected for the freight or cargo 3 at which the desired environmental conditions are fulfilled and a route to this parking place is also planned.

In order to find the route or the parking place, the autonomous guided vehicle 1 receives information over its wireless interface 8 from a sensor network comprising sensors installed in an environment of the autonomous guided vehicle 1 and which measure environmental conditions (such as humidity, temperature, sunlight etc.).

On the basis of the information from the sensor network the route or the parking place is now planned for the autonomous guided vehicle 1. This enables requirements for the freight or cargo 3 to be fulfilled in an even better way.

All described exemplary embodiments, variants and scenarios can be combined in any way.

1-19. (canceled)

20. A control system for an autonomous guided vehicle, the autonomous guided vehicle having a loading area for carrying freight or cargo, and the control system being configured to control a driving behavior of the autonomous guided vehicle as a function of a property of the freight or cargo, comprising:
a wireless interface for receiving information from a sensor network having sensors installed in an environment of the autonomous guided vehicle and configured to measure environmental conditions;
wherein the property of the freight or cargo specifies environmental conditions required by the freight or cargo; and
a controller configured, on a basis of information received from the sensor network, to plan a route or parking place for the autonomous guided vehicle at which the environmental conditions required by the freight or cargo will be satisfied.

21. The control system according to claim 20, which further comprises:
a sensor capable of measuring a position or a weight of the freight or cargo; and
means for stopping the autonomous guided vehicle or for outputting a warning message if a sensor measurement indicates that the freight or cargo has slipped or fallen off.

22. The control system to according claim 20, wherein:
said wireless interface is enabled to receive the property of the freight or cargo;
a processing unit is configured to determine limit values for an acceleration, curve negotiation, or braking of the autonomous guided vehicle from the property of the freight or cargo, the limit values avoiding a possibility that the freight or cargo may slip off or become damaged; and
a driving behavior of the autonomous guided vehicle is controlled so that the limit values will not be exceeded.

23. The control system according to claim 22, which further comprises:
an acceleration sensor; and
wherein the driving behavior of the autonomous guided vehicle is controlled, on the basis of measured values of the acceleration sensor, so that the limit values will not be exceeded.

24. The control system according to claim 22, wherein said wireless interface is configured for reading out RFID tags attached to the freight or cargo and containing information about the property of the freight or cargo.

25. The control system according to claim 22, wherein said wireless interface is configured for receiving a transport order which specifies the property of the freight or cargo.

26. The control system according to claim 22, wherein:
said wireless interface is configured for communication with other autonomous guided vehicles; and
wherein the control system is configured to synchronize the driving behavior of the autonomous guided vehicle with at least one second autonomous guided vehicle, using said wireless interface, so that bulky freight or cargo may be transported jointly by two or more autonomous guided vehicles.

27. An autonomous guided vehicle, comprising a control system according to claim 20.

28. A method for operating an autonomous guided vehicle, the method which comprises:
loading a load area of the autonomous guided vehicle with freight or cargo;
controlling a movement of the autonomous guided vehicle with a control system as a function of a property of the freight or cargo;
receiving information from a sensor network having sensors installed in an environment of the autonomous guided vehicle and measuring environmental conditions;
deriving from the property of the freight or cargo environmental conditions required by the freight or cargo; and
based on the information from the sensor network, planning a route or parking place for the autonomous guided vehicle at which the required environmental conditions needed by the freight or cargo are satisfied.

29. The method according to claim 28, which further comprises:
measuring a position or weight of the freight or cargo with a sensor; and
if the sensor measurement indicates that the freight or cargo will slip or fall off, stopping the autonomous guided vehicle or outputting a warning message.

30. The method according to claim 28, which comprises:
receiving information concerning the property of the freight or cargo via a wireless interface;
determining from the property of the freight or cargo, with a processor unit, limit values for an acceleration, a curve negotiation, or braking of the autonomous guided vehicle, with slippage or damage to the freight or cargo being prevented below the limit values; and
controlling the driving behavior of the autonomous guided vehicle so that the limit values are not exceeded.

31. The method according to claim 30, which comprises using the measured values of an acceleration sensor to control the driving behavior of the autonomous guided vehicle so that the limit values will not be exceeded.

32. The method according to claim 30, which comprises attaching RFID tags to the freight or cargo which contain the property of the freight or cargo are read out via the wireless interface.

33. The method according to claim 30, which comprises receiving a transport order that specifies the property of the freight or cargo via the wireless interface.

34. The method according to claim 30, which comprises synchronizing the driving behavior of the autonomous guided vehicle by communication via the wireless interface with at least one second autonomous guided vehicle so that bulky freight or cargo may be carried jointly with the second autonomous guided vehicle.

35. A computer-readable data medium, comprising computer program code stored on the computer-readable medium for executing the method according to claim 28 when loaded into and run on a computer.

36. A computer program, comprising computer program code which, when run on a computer executes the method according to claim 28.
